(19) United States
(12) Patent Application Publication
(10) Pub. No.: US 2007/0118719 A1
(43) Pub. Date: May 24, 2007

(54) Semiconductor memory and method for controlling the same

(76) Inventors: Takao Ozeki, Osaka (JP); Makoto Arita, Kyoto (JP); Kunisato Yamaoka, Osaka (JP); Shunichi Iwanari, Kyoto (JP)

Correspondence Address: MCDERMOTT WILL & EMERY LLP, 600 13TH STREET, N.W., WASHINGTON, DC, 20005-3096, US

(21) Appl. No.: 11/595,896

(22) Filed: Nov. 13, 2006

(30) Foreign Application Priority Data
Nov. 18, 2005 (JP) 2005-334610

(51) Int. Cl. G06F 12/00

(52) U.S. Cl. 711/202

(57) ABSTRACT

There is provided a method for controlling a semiconductor memory which includes a memory cell array including a plurality of multivalued memory cells where, in each of the memory cells, a first write operation allows storage of data in a first page address and a second write operation allows storage of data in a second page address, the method comprising an address conversion table processing step and an address scramble step. At the address conversion table processing step, an address conversion table for address conversion is generated by, in each of the plurality of multivalued memory cells, allocating addresses in which writing is to be performed to addresses such that data is written in a second page address after writing of data in a first page address. At the address scramble step, address conversion is performed on an input address according to the address conversion table.

### BACKGROUND OF THE INVENTION

The present invention relates to a semiconductor memory and a method for controlling the same and, specifically, to a semiconductor memory capable of storing multi-value data in each memory cell and a method for controlling the same.

The NAND flash memory has been known as an electrically-rewritable nonvolatile semiconductor device. The NAND flash memory includes transistors connected in series to constitute memory cells, these serially-connected memory cells being connected to a bit line as a single unit. In this NAND flash memory, a write or read operation is performed simultaneously on all or a half of a plurality of cells aligned in a row direction.

Recently, multivalued memories have been developed wherein a plurality of bits are stored in one cell of a NAND flash memory. For example, Japanese Laid-Open Patent Publication No.2001-93288 discloses a method for writing data in a multivalued NAND flash memory.

FIG. 21 illustrates transition of the threshold voltage of a memory cell during writing of data in a multivalued memory. In the case of writing data in a memory cell which is capable of storing 2 bits, data of the first and second pages are sequentially given. If the given data is “1”, threshold voltage Vt of the memory cell is not changed by the write operation, so that the state of the memory cell does not change. That is, writing of data is not performed. If the given data is “0”, threshold voltage Vt of the memory cell is changed by the write operation, and accordingly, the state of the memory cell changes. That is, writing of data is performed.

As shown in FIG. 21, the states that the memory cell can be in are State “0”, State “1”, State “2”, State “3” in ascending order as to threshold voltage Vt. The memory cell in the erased state is in State “0”.

First, data of the first page is written in a memory cell. If the written data is “1”, the data of the memory cell stays in State “0”. If the written data is “0”, the data of the memory cell changes into State “1”. Then, data of the second page is written in the memory cell. If the memory cell in State “1” as a result of the writing of the first page data is externally supplied with data “0”, the memory cell enters State “2”. If the memory cell staying in State “0” even after the writing of the first page data is externally supplied with data “0”, the memory cell enters State “3”.

Thus, in the case of writing the first page in a memory cell being in the erased state (State “0”), if the written data is “1” or “0”, the state of the memory cell enters State “0” or State “1”, respectively. Then, the second page is written, so that the state of the memory cell enters any of State “0”, State “1”, State “2”, and State “3”.

Where the second page is written in a memory cell being in the erased state before writing of the first page, if the written data of the second page is “1” or “0”, the state of the memory cell enters State “0” or State “3”, respectively.

In the floating gate type memory cell, such as a NAND flash memory, or the like, the threshold voltage of a memory cell is increased by writing but decreased by erasing. Therefore, the memory cell in the state of the highest threshold voltage among the four states, i.e., State “3”, cannot be restored to State “1” or State “2” by a write operation. That is, if the second page data is written first, the first page data cannot be written, so that it cannot work as a multivalued memory.

The order of writing in the multivalued memory is limited to the order of the first page and then the second page, and therefore, the write operation cannot be carried out with randomly designated addresses.

### SUMMARY OF THE INVENTION

An objective of the present invention is to enable random designation of addresses for writing of data in a multi-value storable memory cell.

Specifically, the first control method of the present invention is a method for controlling a semiconductor memory which includes a memory cell array including a plurality of multivalued memory cells where, in each of the memory cells, a first write operation allows storage of data in a first page address and a second write operation allows storage of data in a second page address, the method comprising: an address conversion table processing step of generating an address conversion table for address conversion by, in each of the plurality of multivalued memory cells, allocating addresses in which writing is to be performed to addresses such that data is written in a second page address after writing of data in a first page address; an address scramble step of performing address conversion on an input address according to the address conversion table; and a data write step of writing data in an address obtained by the address conversion of the address scramble step.

With this method, an input address is converted such that writing of data in first page addresses of a memory space is performed by priority. Therefore, writing of data in a second page address does not occur prior to the first page addresses.

The second control method of the present invention is a method for controlling a semiconductor memory which includes a memory cell array including a plurality of multivalued memory cells where, in each of the memory cells, a first write operation allows storage of data in a first page address and a second write operation allows storage of data in a second page address, the method comprising: an address replacement step of, if a given address is a first page address, replacing the first page address with a corresponding second page address, and if a given address is a second page address, replacing the second page address with a corresponding first page address; a flag determination step of, if address replacement has occurred, generating an address replacement flag indicative of the occurrence of the address replacement in association with an input address; a flag storage step of storing the address replacement flag; and a data write step of writing data in the memory cell array, wherein if the input address is a second page address and writing of data has not occurred in a first page address corresponding to the second page address, or if the input address is a first page address and writing of data has occurred in this first page address, the address replacement step is performed on the input address, and the data write step is performed using the address obtained by the address replacement, and if otherwise, the data write step is performed using the input address without performing the address replacement step.

With this method, even when an address is input such that writing of data in a second page address may occur prior to first page addresses, writing of data actually occurs in the first page addresses prior to the second page address.

According to the present invention, writing of data occurs in the first page addresses prior to the second page addresses irrespective of the order of input addresses. Therefore, storage of data in a multivalued memory cell can be normally carried out.

### BRIEF DESCRIPTION OF THE DRAWINGS

FIG. 1 is a block diagram showing the structure of a semiconductor memory according to embodiment 1 of the present invention.

FIG. 2 is a flowchart illustrating the process flow in the semiconductor memory of FIG. 1.

FIG. 3 illustrates an example of an address conversion table.

FIG. 4 is a flowchart illustrating another example of the process flow in the semiconductor memory of FIG. 1.

FIG. 5 illustrates an example of an address conversion table used for the process of FIG. 4.

FIG. 6 is a block diagram showing the structure of a semiconductor memory according to embodiment 2 of the present invention.

FIG. 7 is a block diagram showing the structure of a semiconductor memory according to embodiment 3 of the present invention.

FIG. 8 is a flowchart illustrating the process flow in the semiconductor memory of FIG. 7.

FIG. 9 illustrates an example of an address conversion table used for the process of FIG. 8.

FIG. 10 is a block diagram showing the structure of a semiconductor memory according to embodiment 4 of the present invention.

FIG. 11 is a block diagram showing the structure of a semiconductor memory according to the first variation of embodiment 4 of the present invention.

FIG. 12 is a block diagram showing the structure of a semiconductor memory according to the second variation of embodiment 4 of the present invention.

FIG. 13 is a block diagram showing the structure of a semiconductor memory according to embodiment 5 of the present invention.

FIG. 14 is a flowchart illustrating the process flow in the semiconductor memory of FIG. 13.

FIG. 15 is a block diagram showing the structure of a semiconductor memory according to the first variation of embodiment 5 of the present invention.

FIG. 16 is a circuit diagram showing an example of the structure of a memory cell array of FIG. 15.

FIG. 17 is a block diagram showing the structure of a semiconductor memory according to the second variation of embodiment 5 of the present invention.

FIG. 18 illustrates the format of data stored in a flag storage circuit of FIG. 17.

FIG. 19 is a flowchart illustrating the process flow performed between a control circuit and the flag storage circuit of FIG. 17.

FIG. 20 illustrates another example of the format of data stored in a flag storage circuit of FIG. 17.

FIG. 21 illustrates the transition of the threshold voltage of a memory cell in writing of data in a multivalued memory.

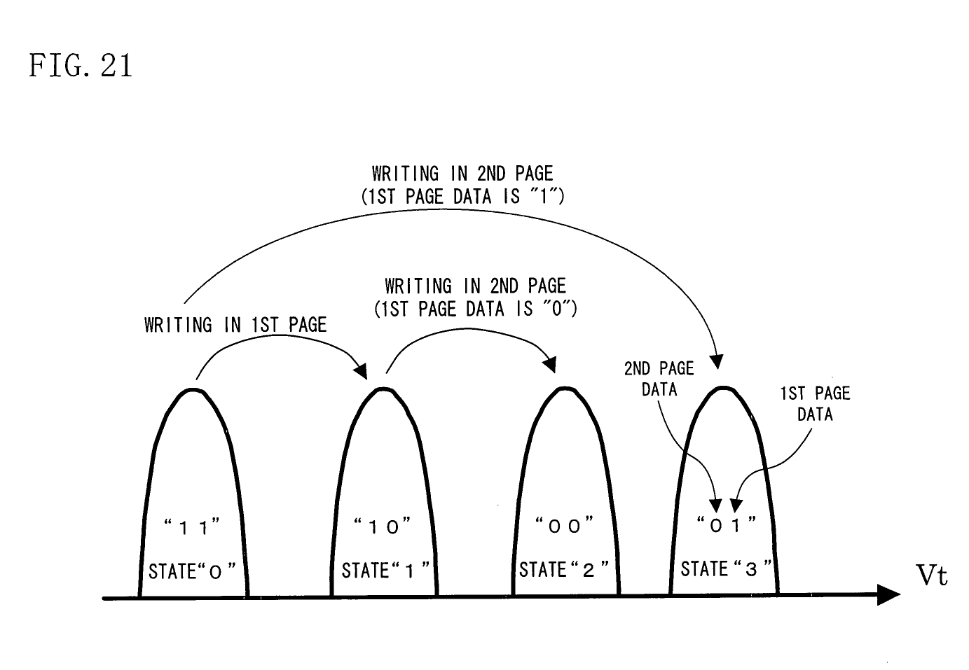

### DESCRIPTION OF THE PREFERRED EMBODIMENTS

Hereinafter, embodiments of the present invention will be described with reference to the drawings.

### Embodiment 1

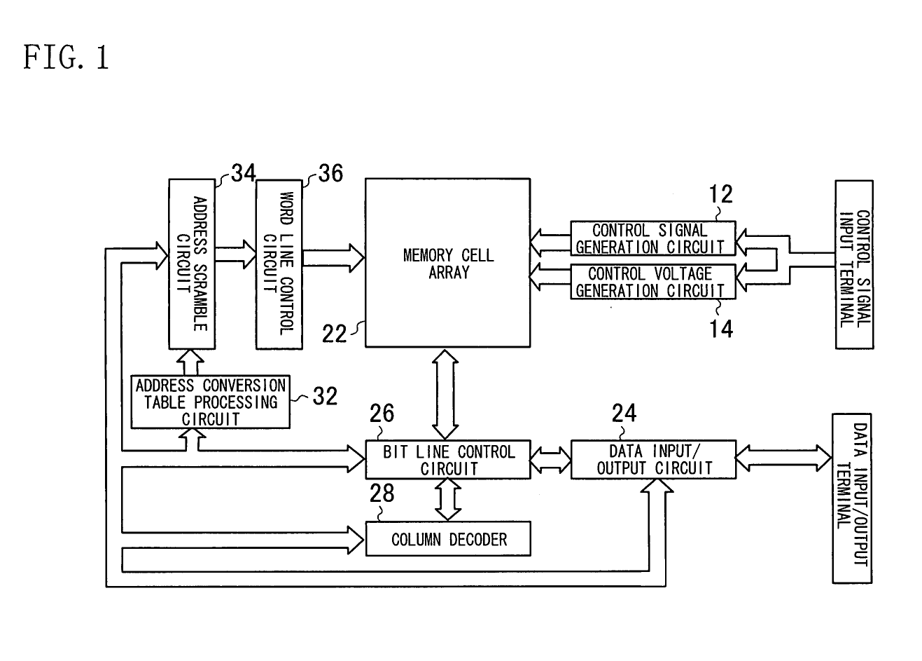

FIG. 1 is a block diagram showing the structure of a semiconductor memory according to embodiment 1 of the present invention. The semiconductor memory of FIG. 1 is, for example, a NAND flash memory, which includes a control signal generation circuit 12, a control voltage generation circuit 14, a memory cell array 22, a data input/output circuit 24, a bit line control circuit 26, a column decoder 28, an address conversion table processing circuit 32, an address scramble circuit 34, and a word line control circuit 36.

The memory cell array 22 includes a plurality of bit lines, a plurality of word lines, a common source line, and a plurality of memory cells arranged in a matrix which are capable of electrically rewriting data. In this example, each memory cell is capable of storing four-value data (2 bits). The bit line control circuit 26 includes a plurality of data storage circuits and operates through bit lines to read memory cell data from the memory cell array 22, to detect the state of the memory cells, and to apply a write control voltage to the memory cells for writing of data.

The column decoder 28 selects a data storage circuit in the bit line control circuit 26. The selected data storage circuit receives memory cell data from the memory cell array 22 and outputs the memory cell data through the data input/output circuit 24 and a data input/output terminal to the outside. Write data externally input at the data input/output terminal is input through the data input/output circuit 24 to a data storage circuit selected by the column decoder 28.

The control signal generation circuit 12 and the control voltage generation circuit 14 are controlled according to a control signal externally input through a control signal input terminal. The control signal generation circuit 12 controls the memory cell array 22, the data input/output circuit 24, the bit line control circuit 26, the column decoder 28, and the word line control circuit 36. The control voltage generation circuit 14 generates voltages necessary for writing, verifying, reading, and erasing of data, and supplies the generated voltages to the memory cell array 22, the data input/output circuit 24, the bit line control circuit 26, the column decoder 28, and the word line control circuit 36. The word line control circuit 36 selects a word line in the memory cell array 22 to supply the selected word line with a voltage necessary for reading, writing, or erasing of data.

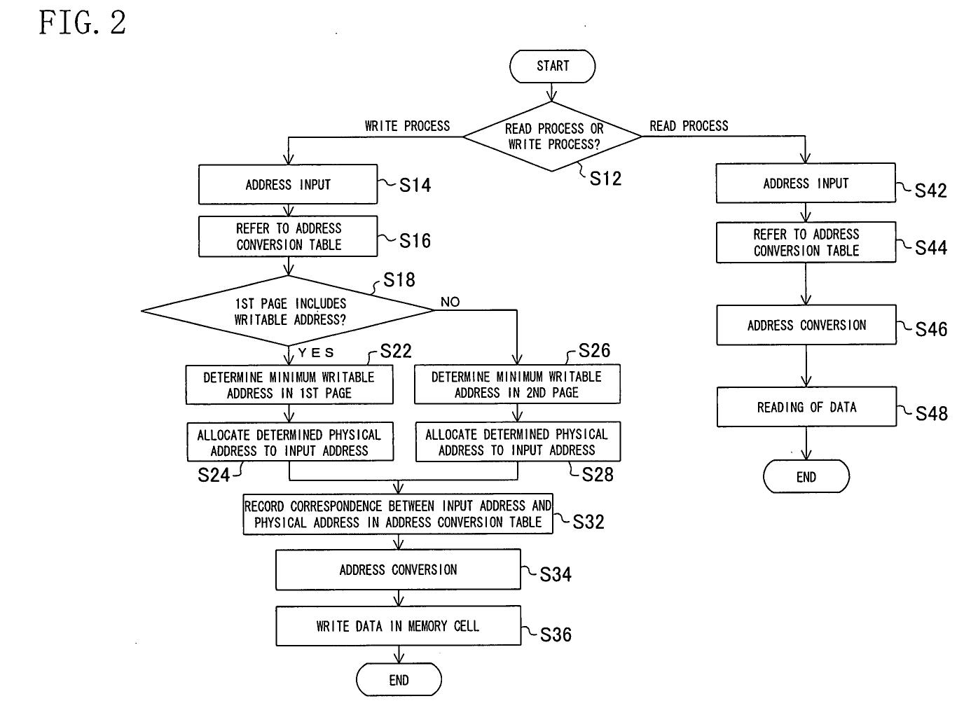

FIG. 2 is a flowchart illustrating the process flow in the semiconductor memory of FIG. 1. The operation of the semiconductor memory of FIG. 1 is now described with reference to FIG. 2.

At step S12, the control signal generation circuit 12 determines whether to perform a read process or write process according to a control signal input at the control signal input terminal. If the write process is selected, the operation proceeds to step S14. If the read process is selected, the operation proceeds to step S42.

At step S14, the address of data which is to be written is input to the data input/output circuit 24 through the data input/output terminal. The data input/output circuit 24 forwards the input address to the address conversion table processing circuit 32 and the address scramble circuit 34.

At step S16, the bit line control circuit 26 retrieves an address conversion table from the memory cell array 22 and forwards the retrieved table to the address conversion table processing circuit 32 though the data input/output circuit 24.

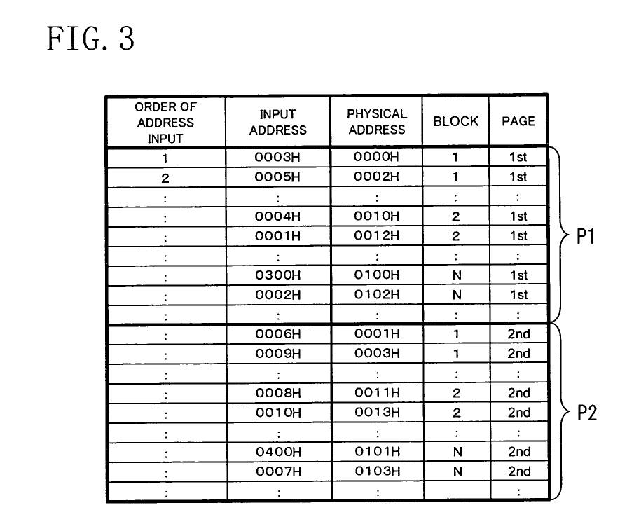

FIG. 3 illustrates an example of the address conversion table. The address conversion table represents the relationship between input addresses and physical addresses which are actual addresses in a memory space. Referring to FIG. 3, the address conversion table shows, for each input address, a corresponding physical address, the block number of the physical address, and which page (1st or 2nd) the physical address exists in. The block is a unit for erasure of written data. In FIG. 3, tables P1 and P2 are conversion tables for the first page and the second page, respectively.

At step S18, the address conversion table processing circuit 32 refers to the address conversion table to check whether or not the first page includes a writable address. The writable address is a physical address which is not associated with any input address in the address conversion table and in which data has not been written. If the first page includes a writable address, the operation proceeds to step S22. If not, i.e., if all the physical addresses of the first page of the memory cell array 22 have been allocated, the operation proceeds to step S26.

At step S22, the address conversion table processing circuit 32 determines the minimum address among the writable addresses of the first page. At step S24, the address conversion table processing circuit 32 allocates the physical address determined at step S22 to the input address. For example, in FIG. 3, it is assumed that the writable addresses of the first page are even-numbered addresses, and the even-numbered addresses of physical addresses 0000H to 0100H have been allocated as first page addresses to the input addresses. In this case, physical address 0102H is allocated as a first page address to input address 0002H.

At step S26, the address conversion table processing circuit 32 determines the minimum address among the writable addresses of the second page. At step S28, the address conversion table processing circuit 32 allocates the physical address determined at step S26 to the input address.

At step S32, the address conversion table processing circuit 32 adds the correspondence between the input address and the physical address newly established at step S24 or step S28 to the address conversion table retrieved at step S16, thereby generating a new address conversion table. The address conversion table processing circuit 32 records the new address conversion table in the memory cell array 22 and, meanwhile, forwards the new address conversion table to address scramble circuit 34.

At step S34, the address scramble circuit 34 uses the address conversion table to convert the input address to a corresponding physical address. At step S36, the address scramble circuit 34 outputs the obtained physical address to the bit line control circuit 26 and the word line control circuit 36 and writes input data in this physical address of the memory cell array 22.

At step S42, the address of data which is to be read is input to the data input/output circuit 24 through the data input/output terminal. The data input/output circuit 24 forwards the input address to the address scramble circuit 34. At step S44, the bit line control circuit 26 reads the address conversion table from the memory cell array 22 and forwards this table to the address conversion table processing circuit 32 though the data input/output circuit 24. The address conversion table processing circuit 32 forwards the address conversion table to the address scramble circuit 34.

At step S46, the address scramble circuit 34 uses the address conversion table to convert the input address to a physical address. At step S48, the address scramble circuit 34 outputs the obtained physical address to the bit line control circuit 26 and the word line control circuit 36 and transfers the data of this physical address from the memory cell array 22 to the data input/output circuit 24.

Thus, the semiconductor memory of FIG. 1 converts an input address to write data in a first page address of a memory space by priority. As a result, no data is written in a second page address prior to a first page address. When externally providing addresses, it is not necessary to consider the order of the addresses, and therefore, the flexibility in address selection for writing of data is improved.

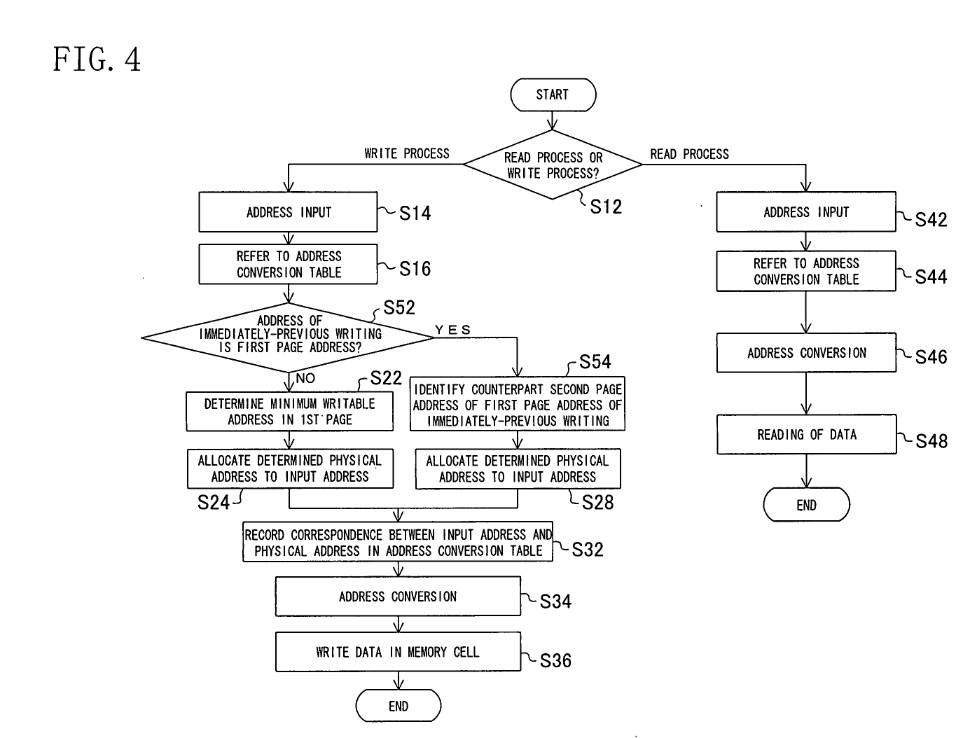

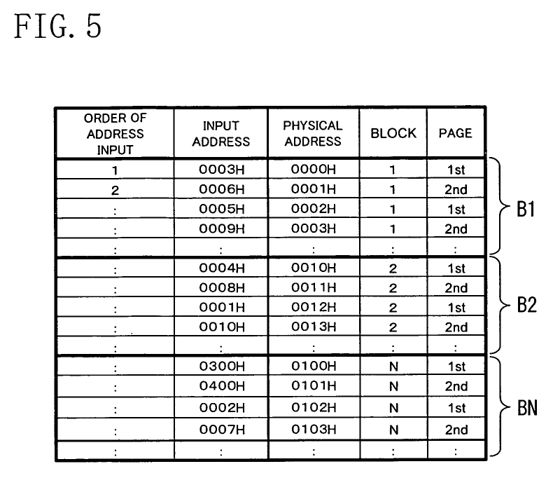

FIG. 4 is a flowchart illustrating another example of the process flow in the semiconductor memory of FIG. 1. The flowchart of FIG. 4 is substantially the same as that of FIG. 2 except for steps S52 and S54 in place of steps S18 and S26. FIG. 5 illustrates an example of an address conversion table used for the process of FIG. 4. In FIG. 5, tables B1, B2, and BN are conversion tables for Block 1, Block 2, and Block N.

At step S52, the address conversion table processing circuit 32 determines whether or not the address in which immediately-previous writing has occurred is a first page address. If it is a first page address, the operation proceeds to step S54. If it is not a first page address, the operation proceeds to step S22.

At step S54, the address conversion table processing circuit 32 identifies a second page address which is the counterpart of the first page address of the immediately-previous writing, i.e., an address of the second page of the memory cell in which the immediately-previous writing has occurred. For example, where the address in which the immediately-previous writing has occurred is address 0003H of the first page, and address 0003H corresponds to physical address 0000H, the address conversion table processing circuit 32 operates for input address 0006H to identify address 0001H of the second page which is the counterpart of physical address 0000H (see FIG. 5).

In the process of FIG. 4, data can be sequentially written in ascending order as to the physical address. Thus, the writing of data occurs in all the addresses of a block (sector) before the writing in the next block. Therefore, it is unnecessary in more cases to erase a plurality of blocks (sectors) in order to erase data.

### Embodiment 2

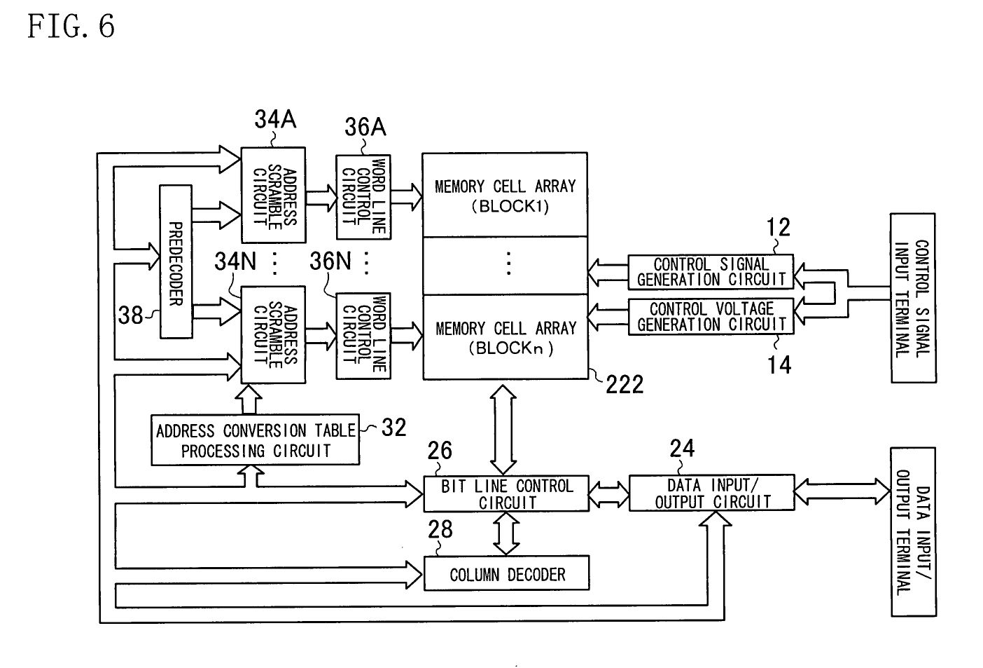

FIG. 6 is a block diagram showing the structure of a semiconductor memory according to embodiment 2 of the present invention. The semiconductor memory of FIG. 6 is substantially the same as the semiconductor memory of FIG. 1 except for including n address scramble circuits 34A, . . . 34N (n is an integer equal to or greater than 2) in substitution for the address scramble circuit 34, and n word line control circuits 36A, . . . 36N in substitution for the word line control circuit 36, and further includes a predecoder 38. The semiconductor memory of FIG. 6 also includes a memory cell array 222 in substitution for the memory cell array 22. The word line control circuits 36A, . . . 36N are divisions of the word line control circuit 36 so as to correspond to n blocks of the memory cell array 222.

The memory cell array 222 has n blocks, Block 1 to Block n, which are connected to the word line control circuits 36A, . . . 36N, respectively. The word line control circuits 36A, . . . 36N are connected to the address scramble circuits 34A, . . . 34N, respectively.

The predecoder 38 outputs an input address to any of the n address scramble circuits 34A, . . . 34N according to the input address. When receiving the address, the selected one of the address scramble circuits 34A, . . . 34N uses a corresponding one of the word line control circuits 36A, . . . 36N to write data in or read data from a corresponding block of the memory cell array 222. In the other respects, the semiconductor memory of FIG. 6 operates in the same way as the semiconductor memories of FIG. 2 and FIG. 4 do. However, in a write process, each of the address scramble circuits 34A, . . . 34N carries out the allocation of memory cells of a corresponding block.

Thus, according to the semiconductor memory of FIG. 6, the number of input and physical addresses which should be under administration in each address scramble circuit can be decreased, and accordingly, the address can be expressed by a smaller number of bits. Therefore, the size of the address conversion table can be decreased. For example, where the memory cell array has two blocks, the most significant bit of the physical addresses of the first block has a different value from that of the second block.

### Embodiment 3

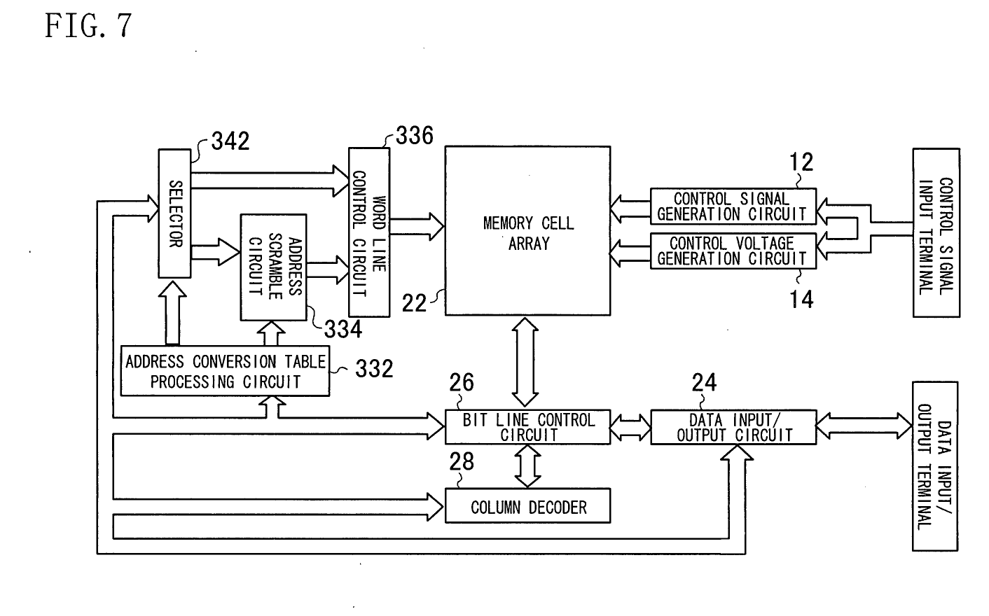

FIG. 7 is a block diagram showing the structure of a semiconductor memory according to embodiment 3 of the present invention. The semiconductor memory of FIG. 7 is substantially the same as the semiconductor memory of FIG. 1 except for including an address conversion table processing circuit 332, an address scramble circuit 334, and a word line control circuit 336 in substitution for the address conversion table processing circuit 32, the address scramble circuit 34, and the word line control circuit 36, respectively. The semiconductor memory of FIG. 7 further includes a selector 342.

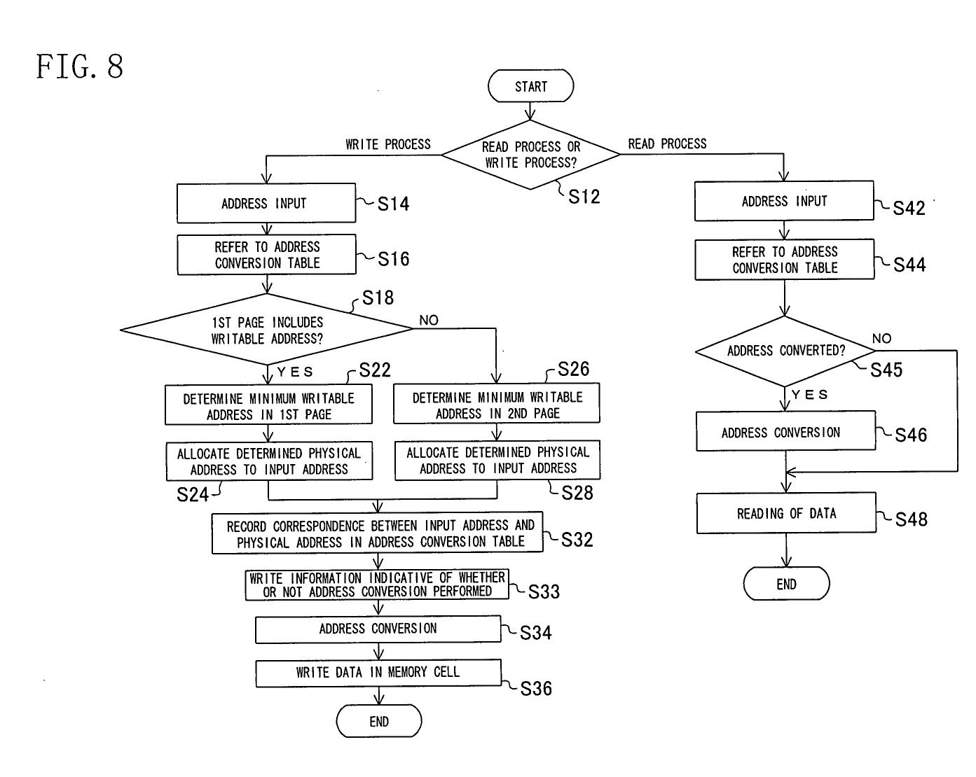

FIG. 8 is a flowchart illustrating the process flow in the semiconductor memory of FIG. 7. The flowchart of FIG. 8 includes step S33 and step S45 in addition to the flowchart of FIG. 2.

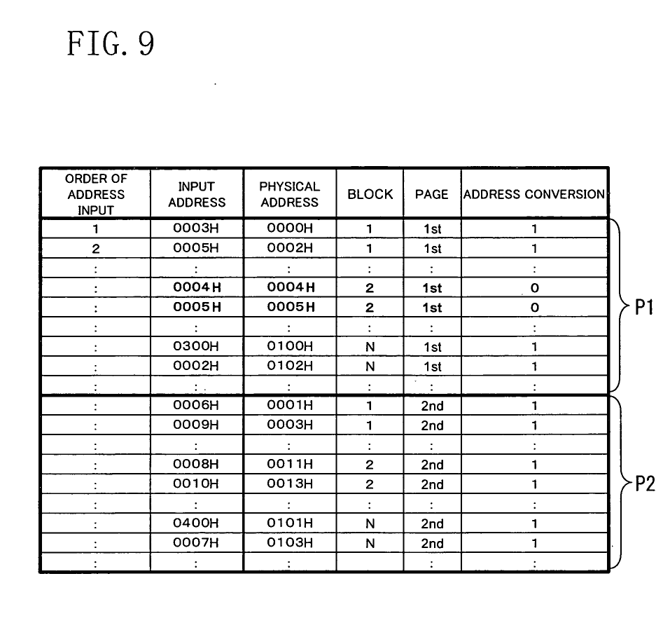

FIG. 9 illustrates an example of an address conversion table used for the process of FIG. 8. The address conversion table of FIG. 9 contains, in addition to the address conversion table of FIG. 3, administrative information indicative of whether or not each input address has been converted to a physical address. In FIG. 9, if the administrative information indicative of whether or not address conversion has been performed is “1”, the administrative information indicates that the input address of that row have been converted to a physical address.

In the case of a write process, after the process of step S32 of FIG. 8, the address conversion table processing circuit 332 adds, at step S33, the administrative information indicative of whether or not address conversion has been performed to the address conversion tables stored in the memory cell array 22 and the address scramble circuit 334. The address conversion table processing circuit 332 controls the selector 342 to output an input address to the address scramble circuit 334.

In the case of a read process, after the process of step S44, the address conversion table processing circuit 332 determines, at step S45, whether or not an input address has been address-converted in a write process according to the address conversion table.

If address-converted, the address conversion table processing circuit 332 controls the selector 342 to output the input address to the address scramble circuit 334, and then, the operation proceeds to step S46. If not address-converted, the address conversion table processing circuit 332 controls the selector 342 to output the input address to the word line control circuit 336, and then, the operation proceeds to step S48. In the other respects, the address conversion table processing circuit 332, the address scramble circuit 334, and the word line control circuit 336 operate in the same way as the corresponding circuits of FIG. 1 do.

Thus, according to the semiconductor memory of FIG. 7, when address conversion is unnecessary, the process in the address scramble circuit 334 is also unnecessary. Therefore, the read process speed can be increased.

### Embodiment 4

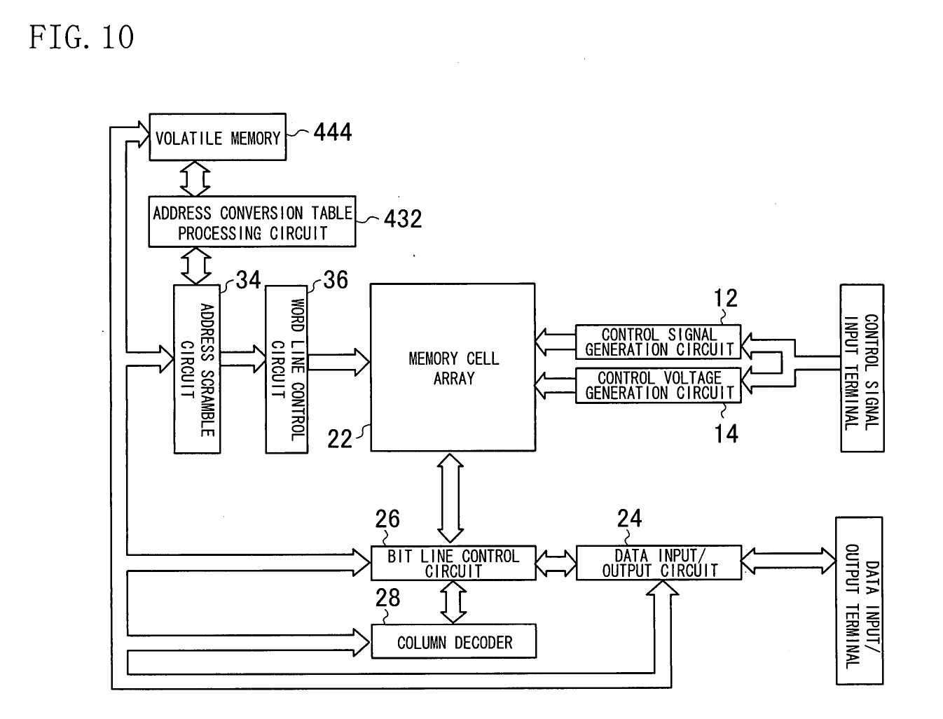

FIG. 10 is a block diagram showing the structure of a semiconductor memory according to embodiment 4 of the present invention. The semiconductor memory of FIG. 10 is substantially the same as the semiconductor memory of FIG. 1, except for including an address conversion table processing circuit 432 in substitution for the address conversion table processing circuit 32 and further including a randomly-accessible volatile memory 444.

When powering on, the bit line control circuit 26 retrieves the address conversion table from the memory cell array 22 and forwards the retrieved address conversion table to the volatile memory 444 through the data input/output circuit 24. The address conversion table processing circuit 432 reads the address conversion table from and writes the address conversion table in the volatile memory 444 instead of the memory cell array 22. When powering off, the address conversion table processing circuit 432 retrieves the address conversion table from the volatile memory 444 and writes the retrieved address conversion table in the memory cell array 22.

According to the semiconductor memory of FIG. 10, it is not necessary to retrieve the address conversion table stored in the memory cell array 22 immediately before reading and writing. Thus, high-speed write and read operations are possible. The address conversion table stored in the volatile memory is backed up in the memory cell array 22, so that the address conversion table can also be used after the next power-on.

### First Variation of Embodiment 4

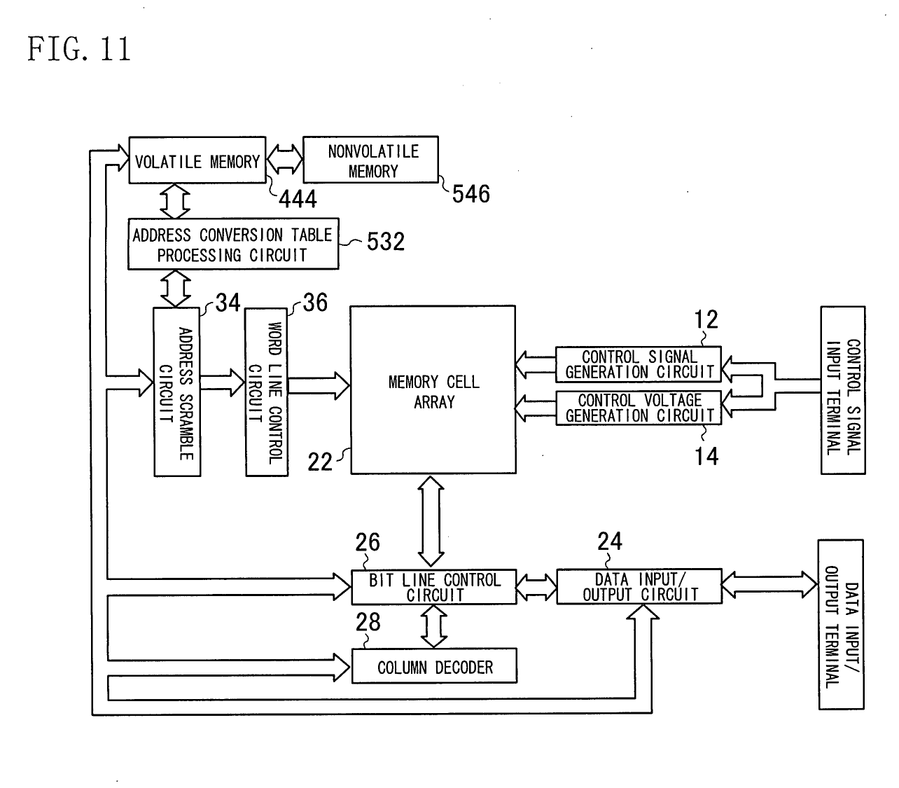

FIG. 11 is a block diagram showing the structure of a semiconductor memory according to the first variation of embodiment 4 of the present invention. The semiconductor memory of FIG. 11 is substantially the same as the semiconductor memory of FIG. 10, except for including an address conversion table processing circuit 532 in substitution for the address conversion table processing circuit 432 and further including a nonvolatile memory 546.

When powering on, the address conversion table processing circuit 532 retrieves the address conversion table from the nonvolatile memory 546 and forwards the retrieved address conversion table to the volatile memory 444. The address conversion table processing circuit 532 reads the address conversion table from and writes the address conversion table in the volatile memory 444. The address conversion table processing circuit 532 operates such that the address conversion table of the volatile memory 444 is forwarded to and stored in the nonvolatile memory 546 on the background.

According to the semiconductor memory of FIG. 11, the address conversion table does not need to be backed up when powering off. Therefore, the process time required for power-off can be shortened.

### Second Variation of Embodiment 4

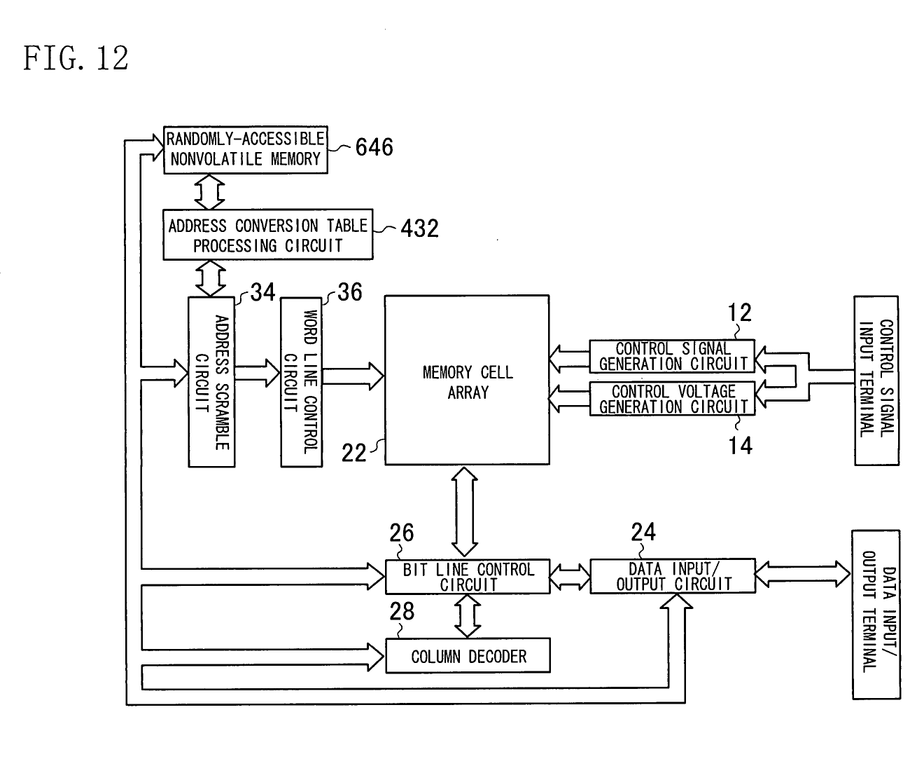

FIG. 12 is a block diagram showing the structure of a semiconductor memory according to the second variation of embodiment 4 of the present invention. The semiconductor memory of FIG. 12 is substantially the same as the semiconductor memory of FIG. 10, except for including a randomly-accessible nonvolatile memory 646 in place of the volatile memory 444.

According to the semiconductor memory of FIG. 12, the address conversion table does not need to be backed up when powering off. Even at the time of a sudden power-off, the address conversion table can be retained.

### Embodiment 5

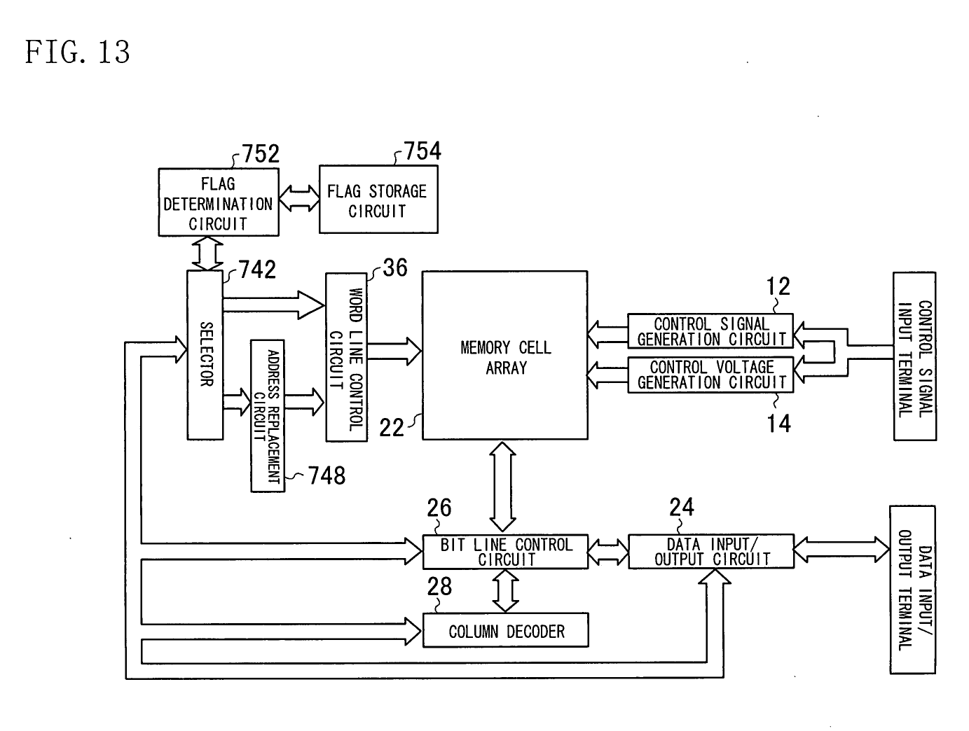

FIG. 13 is a block diagram showing the structure of a semiconductor memory according to embodiment 5 of the present invention. The semiconductor memory of FIG. 13 is substantially the same as the semiconductor memory of FIG. 1 except for including a selector 742, an address replacement circuit 748, a flag determination circuit 752, and a flag storage circuit 754 in substitution for the address conversion table processing circuit 32 and the address scramble circuit 34, respectively.

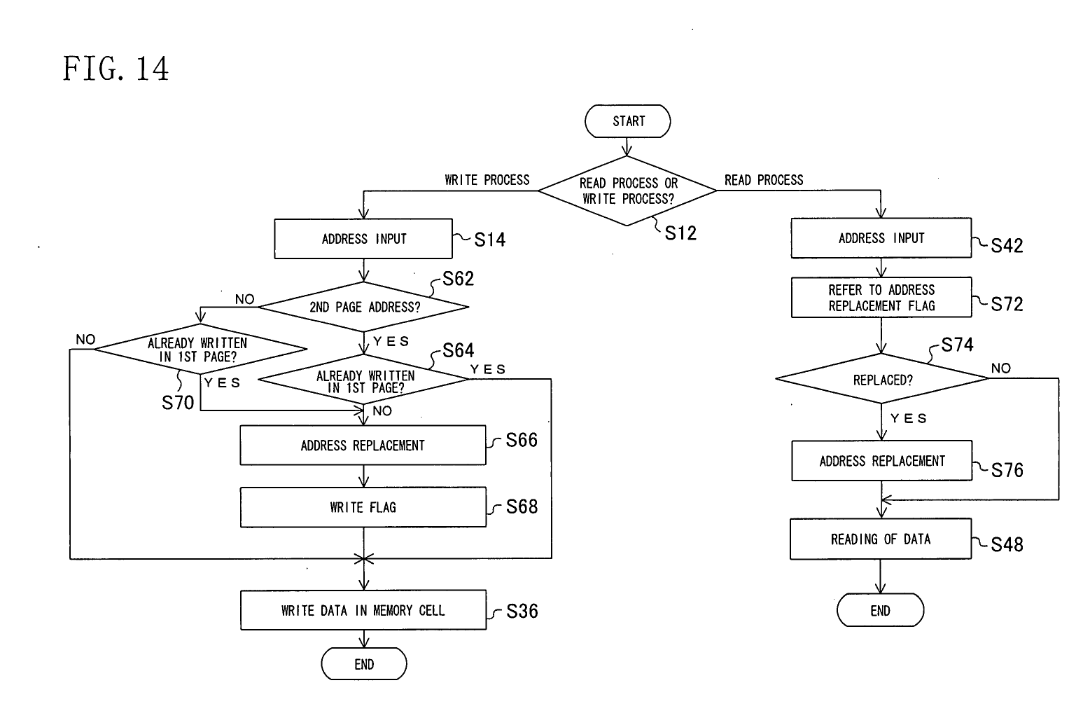

FIG. 14 is a flowchart illustrating the process flow in the semiconductor memory of FIG. 13. The semiconductor memory of FIG. 13 is described with reference to FIG. 14. In FIG. 14, step S12 and step S14 are the same as those of the flowchart of FIG. 2.

In a write operation, the semiconductor memory of FIG. 13 operates as follows. The selector 742 outputs an input address to the word line control circuit 36. At step S62, the selector 742 determines whether or not the input address is a second page address. If the input address is a second page address, the operation proceeds to step S64. If the input address is not a second page address, the operation proceeds to step S70.

At step S64, the selector 742 determines whether or not writing of data has occurred in a first page address corresponding to the input address. If writing of data has occurred there, the operation proceeds to step S36. If writing of data has not occurred there, the operation proceeds to step S66. The determination of step S64 may be realized by actually reading data from the memory cell and determining the state of the memory cell or by retrieving from a separate memory for address management the data indicative of the state of the memory cell as to writing of data.

At step S70, the selector 742 determines whether or not writing of data has occurred in the input address (first page address). If writing of data has occurred there, the operation proceeds to step S66. If writing of data has not occurred there, the operation proceeds to step S36.

At step S66, the selector 742 outputs the input address to the address replacement circuit 748. If the address received from the selector 742 is a second page address, the address replacement circuit 748 replaces the second page address with a corresponding first page address and outputs this first page address to the word line control circuit 36. If the address received from the selector 742 is a first page address, the address replacement circuit 748 replaces the first page address with a corresponding second page address and outputs this second page address to the word line control circuit 36.

The corresponding first and second page addresses are different only in that, normally, the least significant bit of the first page address is “0” and the least significant bit of the second page address is “1”. Thus, the address replacement circuit 748 only needs to change the least significant bit of the input address from “1” to “0” or from “0” to “1”.

At step S68, the flag determination circuit 752 writes an address replacement flag indicative that address replacement has occurred in the flag storage circuit 754 in association with the input address. The process of step S36 is the same as that performed in the flowchart of FIG. 2.

In a read operation, the semiconductor memory of FIG. 13 operates as follows. The selector 742 outputs an input address to the word line control circuit 36. The process of step S42 is the same as that performed in the flowchart of FIG. 2.

At step S72, the flag determination circuit 752 retrieves from the flag storage circuit 754 an address replacement flag corresponding to the input address. At step S74, if the address replacement flag indicates that address replacement has occurred, the operation proceeds to step S76. If not, the operation proceeds to step S48.

At step S76, the selector 742 outputs the input address to the address replacement circuit 748. The address replacement circuit 748 performs address replacement on the input address in the same way as step S66 and outputs the resultant address to the word line control circuit 36. The process of step S48 is the same as that performed in the flowchart of FIG. 2.

Thus, according to the semiconductor memory of FIG. 13, even when as for a certain memory cell an address is input such that writing of data may occur in a second page address prior to first page addresses, writing of data actually occurs in the first page addresses prior to the second page address. Therefore, storage of data in a multivalued memory cell is normally carried out irrespective of the order of input addresses.

### First Variation of Embodiment 5

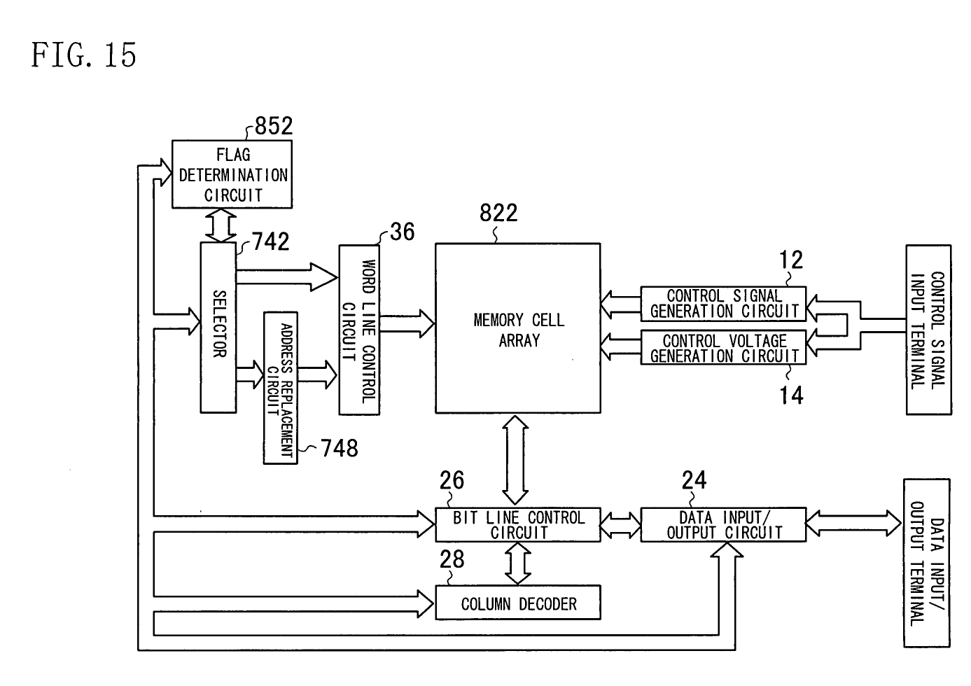

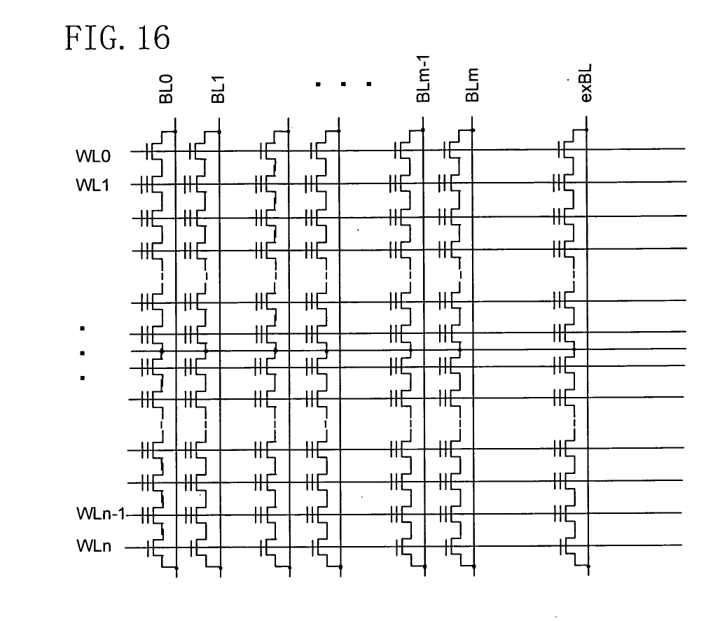

FIG. 15 is a block diagram showing the structure of a semiconductor memory according to the first variation of embodiment 5 of the present invention. The semiconductor memory of FIG. 15 is substantially the same as the semiconductor memory of FIG. 13 except for including a memory cell array 822 and a flag determination circuit 852 in substitution for the memory cell array 22 and the flag determination circuit 752, respectively, and not including the flag storage circuit 754. FIG. 16 is a circuit diagram showing an example of the structure of the memory cell array 822 of FIG. 15. The memory cell array 822 includes memory cells of column exBL in addition to the memory cells of the memory cell array 22.

The flag determination circuit 852 stores the address replacement flag in the memory cells of column exBL and retrieves the address replacement flag from these memory cells, although in the circuit of FIG. 13 the flag determination circuit 752 stores the address replacement flag in the flag storage circuit 754.

The semiconductor memory of FIG. 15 does not need to have the flag storage circuit 754 but is only required to have the memory cells of column exBL in the memory cell array 822 without increasing the number of word lines as compared with the memory cell array 22. Therefore, the area of the semiconductor memory can be decreased.

### Second Variation of Embodiment 5

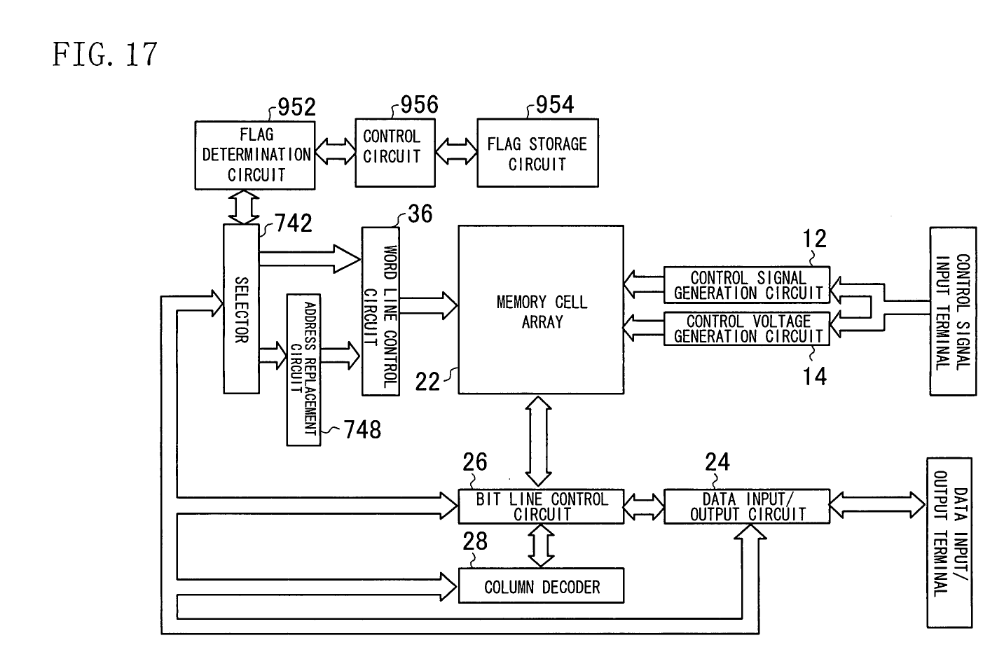

FIG. 17 is a block diagram showing the structure of a semiconductor memory according to the second variation of embodiment 5 of the present invention. The semiconductor memory of FIG. 17 is substantially the same as the semiconductor memory of FIG. 13 except for including a flag determination circuit 952 and a flag storage circuit 954 in substitution for the flag determination circuit 752 and the flag storage circuit 754, respectively, and further including a control circuit 956.

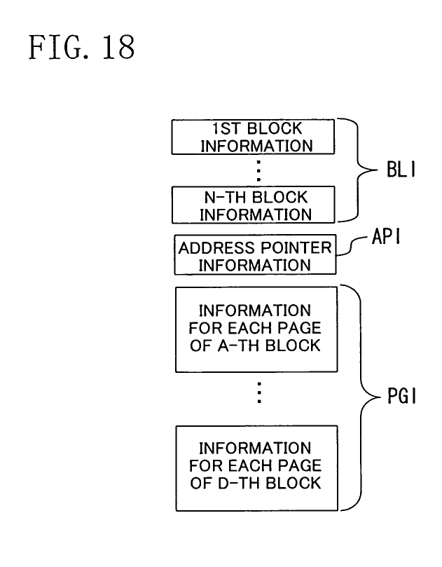

FIG. 18 illustrates the format of data stored in the flag storage circuit 954 of FIG. 17. Herein, it is assumed that the memory cell array 22 includes a plurality of blocks. Address replacement in a block has the following three options:

(1) address replacement occurs in all the pages in the block;

(2) address replacement does not occur in any page in the block; and

(3) the block includes both an address-replaced page and an address-unreplaced page.

In FIG. 18, block information BLI is indicative of to which of these three options each block applies. Page information PGI is indicative of the status of address replacement in each page for a block whose block information BLI represents option (3). Address pointer information API is indicative of the location where page information PGI is stored for a block whose block information BLI represents option (3).

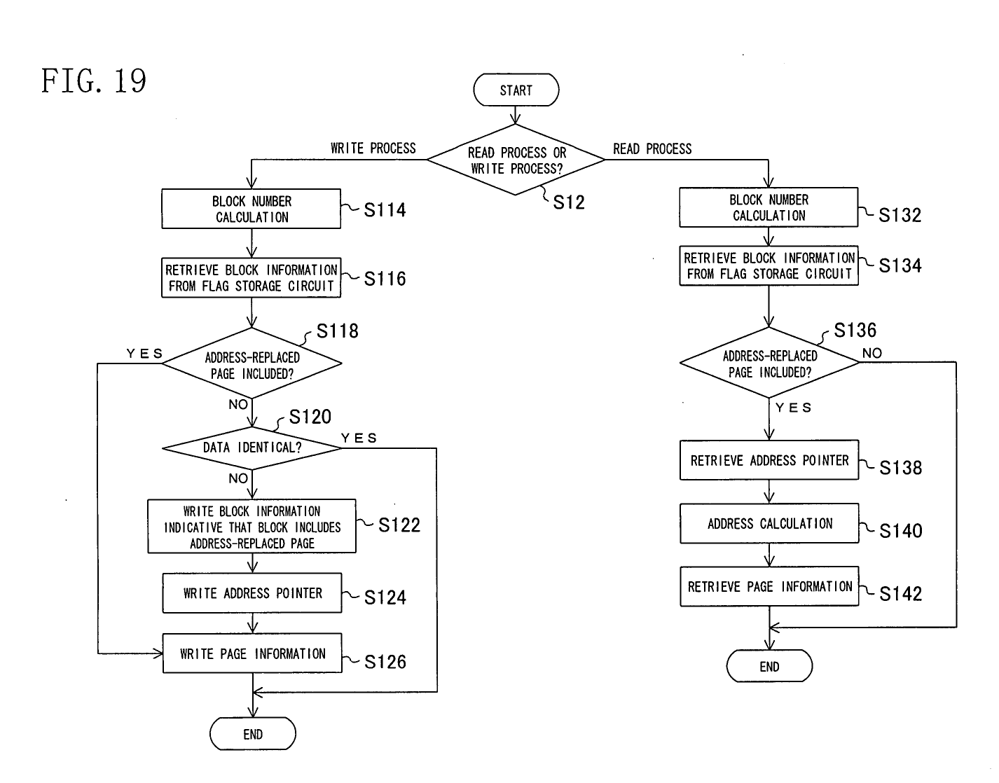

FIG. 19 is a flowchart illustrating the process flow performed between the control circuit 956 and the flag storage circuit 954 of FIG. 17. The semiconductor memory of FIG. 17 is described with reference to FIG. 18.

At step S12, the control signal generation circuit 12 determines, based on a control signal input to the control signal input terminal, which of read and write processes is to be performed. If the write process is to be performed, the operation proceeds to step S114. If the read process is to be performed, the operation proceeds to step SI32. At step Si14, the control circuit 956 determines the number of a block corresponding to an input address.

At step S116, the control circuit 956 retrieves from the flag storage circuit 954 block information BLI of that block. At step S118, the control circuit 956 determines based on block information BLI whether or not the block includes an address-replaced page. If the block includes an address-replaced page, the operation proceeds to step S126. If the block does not include any address-replaced page, the operation proceeds to step S120.

At step S120, the control circuit 956 determines whether or not the retrieved block information BLI is identical with block information BLI which is going to be written. If identical, the operation is ended because the states of the pages are definite. If not identical, the operation proceeds to step S122. At step S122, the control circuit 956 writes in the flag storage circuit 954 block information BLI indicative that the block includes an address-replaced page.

At step S124, the control circuit 956 writes in the flag storage circuit 954 address pointer information API indicative of the location where page information PGI which is going to be written at step S126 is stored. At step S126, the control circuit 956 writes in the flag storage circuit 954 page information PGI indicative of the status of address replacement in each page. As a result of such a process, the states of the pages are definite.

The processes of step S132 and step S134 are the same as those of step S114 and step S116, respectively. At step S136, the control circuit 956 determines based on block information BLI whether or not the block includes an address-replaced page. If the block includes an address-replaced page, the operation proceeds to step S138. If the block does not include any address-replaced page, the operation is ended because the states of the pages are definite.

At step S138, the control circuit 956 retrieves from the flag storage circuit 954 address pointer information API of a block in which reading of data is going to be carried out. At step S140, the control circuit 956 performs an address calculation to determine the address of data which is to be read.

At step S142, the control circuit 956 retrieves from the flag storage circuit 954 page information PGI of the block in which reading of data is going to be carried out. As a result of such a process, the states of the pages are definite.

The semiconductor memory of FIG. 17 does not need to store information about address replacement for all the pages. Therefore, when almost all of data written in the memory cell array 22 do not require address replacement, i.e., when only part of data requires address replacement, the storage capacity of the flag storage circuit 954 can be decreased.

Now consider, for example, a multivalued memory which has 2048 pages. In the semiconductor memory of FIG. 13, the flag storage circuit 754 is required to have a capacity of 2048 bits. In the semiconductor memory of FIG. 17, where one block consists of 64 pages and accordingly there are 32 blocks, the capacity of 32 bits is necessary for block information. Where the allowable number of blocks which include both an address-replaced page and an address-unreplaced page is eight (8), the capacity of 64×8 =512 bits are necessary for page information. Since the total of the bits is 32+512=544 bits, the capacity of the flag storage circuit 954 can be decreased.

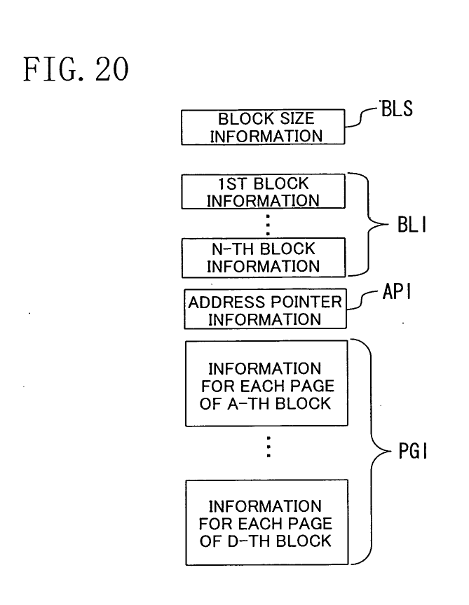

FIG. 20 illustrates another example of the format of data stored in the flag storage circuit 954 of FIG. 17. The format of FIG. 20 has a region for block size information BLS in addition to the format of FIG. 18.

In the semiconductor memory of FIG. 17, where there are 2048 pages and the allowable number of blocks which include both an address-replaced page and an address-unreplaced page is eight (8), the flag storage circuit 954 is required to have a capacity of 544 bits. As the allowable number is increased as much as possible, the randomness in selection between writing in the first page and writing in the second page is increased. The control circuit 956 stores in the flag storage circuit 954 block size information BLS indicative of the block size of the memory cell array 22.

It is assumed herein that the capacity of the flag storage circuit 954 is, for example, 544 bits, and the capacity of eight (8) bits is necessary for storage of the block size. It is also assumed herein that one block consists of 32 pages and accordingly the number of blocks is 64, and therefore, the capacity of 64 bits is necessary for the block information. Under these conditions, the allowable number of blocks which include both an address-replaced page and an address-unreplaced page is (544−64−8)+32=14 (truncated to an integer).

Thus, the allowable number of blocks which include both an address-replaced page and an address-unreplaced page can be increased by changing the block size. Therefore, the capacity of the flag storage circuit 954 can be decreased while maintaining the randomness in data written in the memory cell array 22.

As described above, the present invention is useful for a semiconductor memory having a multi-value storable memory cell.

What is claimed is:

1. A method for controlling a semiconductor memory which includes a memory cell array including a plurality of multivalued memory cells where, in each of the memory cells, a first write operation allows storage of data in a first page address and a second write operation allows storage of data in a second page address, the method comprising:
an address conversion table processing step of generating an address conversion table for address conversion by, in each of the plurality of multivalued memory cells, allocating addresses in which writing is to be performed to addresses such that data is written in a second page address after writing of data in a first page address;
an address scramble step of performing address conversion on an input address according to the address conversion table; and
a data write step of writing data in an address obtained by the address conversion of the address scramble step.

2. The control method of claim 1, wherein the address conversion table processing step includes allocating a second page address after no more first page address of the memory cell array is available for writing of data.

3. The control method of claim 1, wherein the address conversion table processing step includes allocating a first page address of the memory cell array before a second page address corresponding to the first page address is allocated.

4. The control method of claim 1, wherein the address conversion table processing step includes adding, for each address, data indicative of whether or not address conversion needs to be performed to the address conversion table such that, if the address conversion needs to be performed on the input address, data is written in an address obtained by the address conversion of the address scramble step, and if the address conversion does not need to be performed on the input address, data is written in the input address.

5. A method for controlling a semiconductor memory which includes a memory cell array including a plurality of multivalued memory cells where, in each of the memory cells, a first write operation allows storage of data in a first page address and a second write operation allows storage of data in a second page address, the method comprising:
an address replacement step of, if a given address is a first page address, replacing the first page address with a corresponding second page address, and if a given address is a second page address, replacing the second page address with a corresponding first page address;
a flag determination step of, if address replacement has occurred, generating an address replacement flag indicative of the occurrence of the address replacement in association with an input address;
a flag storage step of storing the address replacement flag; and
a data write step of writing data in the memory cell array, wherein if the input address is a second page address and writing of data has not occurred in a first page address corresponding to the second page address, or if the input address is a first page address and writing of data has occurred in this first page address, the address replacement step is performed on the input address, and the data write step is performed using the address obtained by the address replacement, and
if otherwise, the data write step is performed using the input address without performing the address replacement step.

6. A semiconductor memory, comprising:
a memory cell array which includes a plurality of multivalued memory cells where, in each of the memory cells, a first write operation allows storage of data in a first page address and a second write operation allows storage of data in a second page address;
an address conversion table processing circuit for generating an address conversion table for address conversion by, in each of the plurality of multivalued memory cells, allocating addresses in which writing is to be performed to addresses such that data is written in a second page address after writing of data in a first page address; and
an address scramble circuit for performing address conversion on an input address according to the address conversion table such that writing of data is performed in an address obtained by the address conversion.

7. The semiconductor memory of claim 6, wherein the address conversion table processing circuit allocates a second page address after no more first page address of the memory cell array is available for writing of data.

8. The semiconductor memory of claim 6, wherein the address conversion table allocates a first page address of the memory cell array before a second page address corresponding to the first page address is allocated.

9. The semiconductor memory of claim 6, further comprising a predecoder, wherein:
the address conversion table processing circuit generates the address conversion table, for each of a plurality of blocks included in the memory cell array, for performing an address conversion to an address of the block;
the address scramble circuit is divided into divisions respectively corresponding to the plurality of blocks, and each of the address scramble circuit divisions performs an address conversion on an input address according to an address conversion table of a corresponding one of the blocks; and
the predecoder outputs the input address to any of the address scramble circuit divisions according to the input address.

10. The semiconductor memory of claim 6, further comprising a selector which receives the input address,
wherein the address conversion table processing circuit adds to the address conversion table, for each address, data indicative of whether or not address conversion needs to be performed, and
the address conversion table processing circuit controls the selector such that, if the address conversion needs to be performed on the input address, the input address is given to the address scramble circuit, and writing of data is performed in an address obtained by the address conversion, and if the address conversion does not need to be performed on the input address, writing of data in the input address is performed.

11. The semiconductor memory of claim 6, further comprising a randomly-accessible volatile memory,
wherein the address conversion table processing circuit performs reading of the address conversion table from the volatile memory and writing of the address conversion table in the volatile memory.

12. The semiconductor memory of claim 11, further comprising a nonvolatile memory for storing the address conversion table, the nonvolatile memory being coupled to the volatile memory.

13. The semiconductor memory of claim 6, further comprising a randomly-accessible nonvolatile memory,
wherein the address conversion table processing circuit performs reading of the address conversion table from the nonvolatile memory and writing of the address conversion table in the nonvolatile memory.

14. A semiconductor memory, comprising:
a memory cell array which includes a plurality of multivalued memory cells where, in each of the memory cells, a first write operation allows storage of data in a first page address and a second write operation allows storage of data in a second page address;
a selector which receives an input address;
an address replacement circuit for, if an address input to the address replacement circuit is a first page address, replacing the first page address with a corresponding second page address, and if an address input to the address replacement circuit is a second page address, replacing the second page address with a corresponding first page address;
a flag determination circuit for, if address replacement has occurred, generating an address replacement flag indicative of the occurrence of the address replacement in association with the input address; and
a flag storage circuit for storing the address replacement flag,
wherein the selector operates such that if the input address is a second page address and writing of data has not occurred in a first page address corresponding to the second page address, or if the input address is a first page address and writing of data has occurred in this first page address, the input address is output to the address replacement circuit, and writing of data is performed in an address obtained by the address replacement circuit, and if otherwise, writing of data in the input address is performed without address replacement.

15. The semiconductor memory of claim 14, wherein part of the memory cell array constitutes the flag storage circuit.

16. The semiconductor memory of claim 14, wherein the flag storage circuit stores:
block information indicative of whether or not address replacement has been performed for each block of the memory cell array;
page information indicative of the status of address replacement in each page for a block including both an address-replaced page and an address-unreplaced page; and
address pointer information indicative of the location where the page information is stored.

17. The semiconductor memory of claim 16, wherein the flag storage circuit further stores block size information indicative of a block size of the memory cell array.
